(19) United States
(12) Patent Application Publication
(10) Pub. No.: US 2025/0314133 A1
(43) Pub. Date: Oct. 9, 2025

(54) REMOTELY OPERATED ATTACHMENT TO PROVIDE ALIGNMENT BETWEEN VIV FAIRING STRUCTURES

(71) Applicant: Oceaneering International, Inc., Houston, TX (US)

(72) Inventors: Yuri COELHO DEL’SARTO, RIO DE JANEIRO (BR); Rosianita BALENA, CURITIBA PARANÁ (BR)

(73) Assignee: Oceaneering International, Inc., Houston, TX (US)

(21) Appl. No.: 19/172,965

(22) Filed: Apr. 8, 2025

Related U.S. Application Data
(60) Provisional application No. 63/631,676, filed on Apr. 9, 2024.

(51) Int. Cl. E21B 17/00; B33Y 80/00; F16L 1/12

(52) U.S. Cl. CPC E21B 17/006; B33Y 80/00; F16L 1/123

(57) ABSTRACT

A remotely operated tool and fairing aligner aids in bringing back fairing segments' rotational ability and can operate as an aligner for a fairings cleaning process and as a fairing rotator for inspection. Fairing aligner 20 is part of remotely operated tool 1 which attaches to structure 100 where a fairing or fairing segment needs to be cleaned. Fairings 110 may be rotated and restoration of proper functioning of the fairings 110 verified. Remotely operated tool 1 may further have an ability to rotate cleaning module 50 along its axes.

### CROSS-REFERENCE TO RELATED APPLICATIONS

This application claims priority through U.S. Provisional Application 63/631,676 filed on Apr. 9, 2024.

### BACKGROUND OF THE INVENTION

Vortex-induced vibrations (VIV) fairings are subsea structures installed in deep water risers and umbilicals to mitigate vortex shading effects. VIV fairings need the ability to rotate along their axis for a proper function. In addition, during operational life some factors may reduce the VIV fairing performance, such as marine growth, corrosion, mechanism jamming, and the like, or a combination thereof. Marine growth and corrosion reduce the performance of VIV fairing and may get the VIV fairing jammed. This condition makes impossible the VIV fairing rotation and reduces the equipment efficiency.

To restore the proper function, VIV fairings need to be cleaned but VIV fairings may be located in a water depth in which a diver is not able to operate. A diver cannot access the fairing at a water depth to perform cleaning operations. Also, to clean a fairing, the segments must be aligned to each other and the possibility of aligning fairings using an external apparatus provides the possibility of verifying correct operation.

### BRIEF DESCRIPTION OF DRAWINGS

Various figures are included herein which illustrate aspects of embodiments of the disclosed inventions.

FIG. 1 is a view of an exemplary remotely operated tool in partial perspective;

FIG. 2 is a view of an exemplary fairing aligner in partial perspective;

FIG. 3 is a view of an exemplary instrument table in partial perspective; and

FIG. 4 is an exemplary view of in partial perspective of a process of using the remotely operated tool.

### DETAILED DESCRIPTION OF EMBODIMENTS OF THE INVENTION

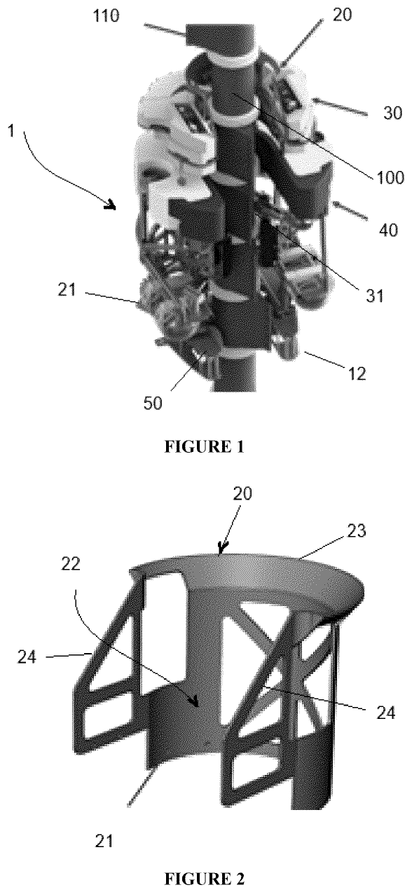

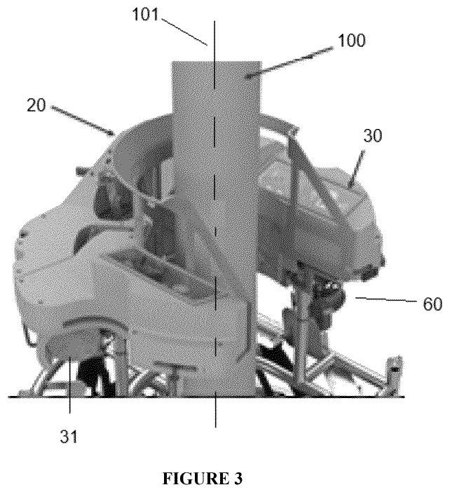

In a first embodiment, referring generally to FIG. 1, remotely operated tool 1, which is typically operative to a maximum water depth of around 1000 m without vessel or remotely operated vehicle (ROV) support, comprises fairing aligner 20, which is adapted to engage an outer diameter of structure 100 (FIG. 3) such as a riser or an umbilical. Remotely operated tool 1 and its components typically comprise a metal such as aluminum; and remotely operated tool mover 12, operatively connected to fairing aligner 20 and operative to move remotely operated tool 1. Fairing aligner 20 may comprise a metal, a polymeric material which may be combined with an additive, or the like, or a combination thereof.

In embodiments, remotely operated tool 1 is adapted to be assembled through use of one or more bolted interfaces 21, welded joints, or manufactured in a monoblock through an additive manufacture.

Referring additionally to FIG. 2, fairing aligner 20 typically comprises a substantially tubular shape and substantially continuous opening 22 along a longitudinal portion of the tubular shape where substantially continuous opening 22 extends the entire length of the longitudinal portion of the tubular shape and is configured to accept structure 100 (FIG. 1) and/or fairing 110 (FIG. 1) within an inner portion of fairing aligner 20 through substantially continuous opening 22. In embodiments, fairing aligner 20 comprises a predetermined number of openings along the longitudinal portion of the tubular shape to reduce the mass of fairing aligner 20. Sides 24 may be sloped, e.g., comprise a triangular portion extending from a first end of fairing aligner 20 downward and outward towards an opposite end of fairing aligner 20. In embodiments, fairing aligner 20 comprises a V shape adapted to provide an alignment between fairings 110 or orientate segments of fairings 110 (FIG. 1).

Referring still to FIG. 1 and referring additionally to FIG. 3, remotely operated tool mover 12 is configured to move remotely operated tool 1 linearly along an axis defined by interior axis 101 (FIG. 3) of structure 100.

In embodiments, remotely operated tool 1 may further comprise instrument table 30, which is typically configured to interface with an upper portion of fairing aligner 20, and instrument table mover 31, which is configured to interface with instrument table 30 and move instrument table 30, e.g., circumferentially with respect to structure 100, to align it with fairing 110 (FIG. 1). If present, bolted interface 21 (FIG. 1) is typically configured to attach a component to instrument table 30, which has the ability to rotate along with its axis. In embodiments, fairing aligner 20 comprises flared portion 23 (FIG. 2) at its upper end and instrument table 30 is positioned or otherwise attached to fairing aligner 20 proximate to flared portion 23.

Instrument table mover 31 may comprise one or more propellers (not shown in the figures) adapted to allow movement underwater. The propellers may comprise a vectorized thruster (not shown in the figures) which has enough power to move the entire remotely operated tool 1 underwater.

In embodiments, remotely operated tool 1 may further comprise attachment tool 40 operatively connected to a lower end of fairing aligner 20. Attachment tool 40 may be adapted to accept and operatively connect to one or more cleaning modules 50 and them about the outer surface of structure 100, e.g., circumferentially along the various axes of, e.g., remotely operated tool 1 such as axis 101 (FIG. 3). Cleaning module 50 may comprise one or more brushes which are adapted to be used to help to remove marine growth from a segment of fairing 110.

In embodiments, remotely operated tool 1 further comprises a subsea waterjet for flexjoint cleaning (<100 m WD), e.g., as part of or otherwise defining attachment tool 40.

Referring to FIG. 3, in embodiments remotely operated tool 1 further comprises a predetermined set of sensors 60 which may comprise a touch-based sensor, a visual inspection sensor such as a camera or a laser scanner, or the like, or a combination thereof.

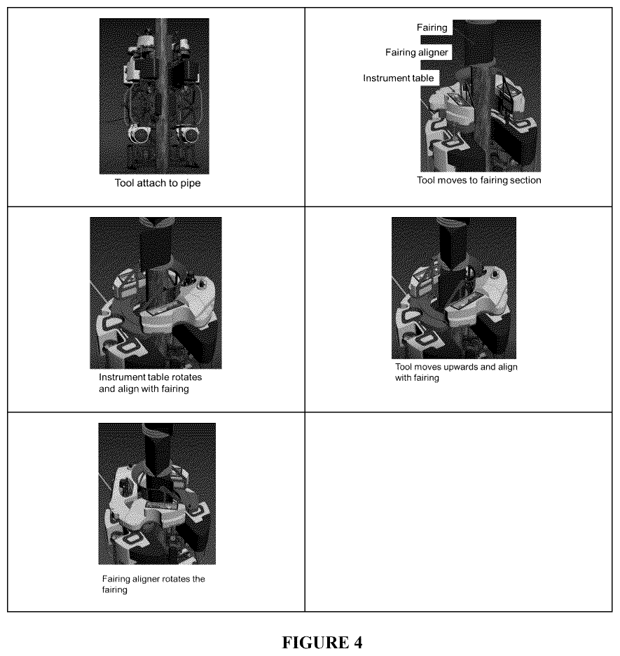

In the operation of exemplary methods, referring to FIG. 1 and to FIG. 4, in most embodiments, remotely operated tool 1 is remotely operated to provide alignment between and restore rotational ability of fairings 110 and does not need a diver or ROV to operate. Fairings 110 may be rotated along their axis using remotely operated tool 1, which is as described above and which is operative without vessel or remotely operated vehicle (ROV) support, by positioning remotely operated tool 1 about an outer surface of structure 100 subsea, where structure 100 comprises one or more fairing sections, each fairing section comprising one or more fairings 110; attaching remotely operated tool 1 to structure 100 subsea; moving remotely operated tool 1 to a desired location proximate a fairing section until remotely operated tool 1 is aligned with a desired fairing 110; and, once aligned, using remotely operated tool 1 to rotate the fairing. In embodiments, once remotely operated tool 1 is attached to structure 100, each fairing segment of a plurality of fairing segments may be rotated individually.

In embodiments where remotely operated tool 1 comprises instrument table 30, moving remotely operated tool 1 to a desired location proximate the fairing section until remotely operated tool 1 is aligned with fairing 110 typically further comprises rotating instrument table 30, e.g., by using instrument table mover 31, until instrument table 30 aligns with fairing 110.

In embodiments where remotely operated tool 1 further comprises attachment tool 40, using remotely operated tool 1 to rotate fairing 110 may further comprise using attachment tool 40 to verify restoration of proper functioning of fairing 110, e.g., by using one or more sensors 60.

Where fairing aligner 20 comprises a V-shape, remotely operated tool 1 typically uses the V shape to provide alignment between a plurality of fairings 110 or a plurality of segments of fairings 110.

In embodiments, fairing aligner 20 may be used or a cleaning process for fairing 110 and the rotation of fairing 110 used in an inspection process. Attachment tool 40 allows remotely operated tool 1 to align and inspect fairings 110 as remotely operated tool 1 transits along structure 100. Fairings 110 may be rotated and proper functioning of fairings 110 restored and verified by sensors 60, e.g., cameras installed in remotely operated tool 1.

The foregoing disclosure and description of the inventions are illustrative and explanatory. Various changes in the size, shape, and materials, as well as in the details of the illustrative construction and/or an illustrative method may be made without departing from the spirit of the invention.

1. A remotely operated tool, operative without vessel or remotely operated vehicle (ROV) support, comprising:
a. a fairing aligner adapted to engage an outer diameter of a structure, the fairing aligner comprising:
i. a substantially tubular shape; and
ii. a substantially continuous opening along a longitudinal portion of the tubular shape and extending the entire length of the longitudinal portion of the tubular shape, the substantially continuous opening configured to allow accepting a fairing within an inner portion of the fairing aligner through the substantially continuous opening; and
b. a remotely operated tool mover operatively connected to the fairing aligner and operative to move linearly along an axis defined by an interior axis of the structure.

2. The remotely operated tool of claim 1, wherein the fairing aligner comprises a V shape adapted to provide an alignment between a plurality of fairings or orient fairing segments.

3. The remotely operated tool of claim 1, wherein the fairing aligner comprises a predetermined number of openings along the longitudinal portion of the tubular shape to reduce mass of the fairing aligner.

4. The remotely operated tool of claim 1, wherein the remotely operated tool comprises a metal.

5. The remotely operated tool of claim 1, wherein the remotely operated tool is adapted to be manufactured in a monoblock through an additive manufacture.

6. The remotely operated tool of claim 1, wherein:
a. the fairing aligner comprises a predetermined set of bolted interfaces; and
b. the remotely operated tool is adapted to be assembled through use of the predetermined set of bolted interfaces or welded joints.

7. The remotely operated tool of claim 6, wherein the predetermined set of bolted interfaces is configured to attach a component to an instrument table, the instrument table comprising an ability to rotate along with its axis.

8. The remotely operated tool of claim 1, wherein the fairing aligner comprises a polymeric material combined with an additive.

9. The remotely operated tool of claim 1, further comprising:
a. an instrument table configured to interface with an upper end of the fairing aligner; and
b. an instrument table mover configured to interface with the instrument table and move the instrument table to align it with the fairing.

10. The remotely operated tool of claim 1, wherein the instrument table is operatively connected to an upper end of the fairing aligner.

11. The remotely operated tool of claim 1, further comprising an attachment tool operatively connected to a lower end of the fairing aligner.

12. The remotely operated tool of claim 11, further comprising a cleaning module operatively connected to the attachment tool and rotatable by the cleaning module about an outer surface of the structure.

13. The remotely operated tool of claim 1, further comprising a predetermined set of sensors.

14. The remotely operated tool of claim 13, wherein the predetermined set of sensors comprises a touch-based sensor, a visual inspection sensor, or both a touch-based sensor and a visual inspection sensor.

15. A method of using a remotely operated tool comprising a fairing aligner adapted to engage an outer diameter of a structure where the fairing aligner comprises a substantially tubular shape and a substantially continuous opening along a longitudinal portion of the tubular shape and extending the entire length of the longitudinal portion of the tubular shape, the substantially continuous opening configured to allow accepting a fairing within an inner portion of the fairing aligner through the substantially continuous opening, and a remotely operated tool mover operatively connected to the fairing aligner and operative to move linearly along an axis defined by an interior axis of the structure, the method comprising
a. positioning the remotely operated tool about an outer surface of a structure subsea, the structure comprising a fairing section, the fairing section comprising a fairing;
b. attaching the remotely operated tool to the structure subsea;
c. moving the remotely operated tool along the structure to a desired location proximate a fairing section until the remotely operated tool is aligned with the fairing;
d. once aligned, using the remotely operated tool to rotate the fairing to restore proper functioning of the fairing; and
e. verifying restoration of proper functioning of the fairing

16. The method of claim 15, wherein:
a. the remotely operated tool further comprises an instrument table; and
b. moving the remotely operated tool to a desired location proximate a fairing section until the remotely operated tool is aligned with the fairing further comprises rotating the instrument table until it aligns with the fairing.

17. The method of claim 16, further comprising rotating each fairing segment of a plurality of fairing segments individually after the remotely operated tool is attached to the structure.

18. The method of claim 17, wherein:
a. the remotely operated tool further comprises an attachment tool; and
b. using the remotely operated tool to rotate the fairing further comprises using the attachment tool to verify restoration of proper functioning of the fairings.

19. The method of claim 15, wherein:
a. the fairing aligner comprises a V-shape; and
b. the remotely operated tool uses the fairing aligner's V shape to provide alignment between a plurality of fairings.

20. The method of claim 15, further comprising:
a. using the fairing aligner to facilitate a cleaning process for the fairing; and
b. using the rotation of the fairing in an inspection process.
